(19) United States
(12) Patent Application Publication
(10) Pub. No.: US 2013/0156679 A1
(43) Pub. Date: Jun. 20, 2013

(54) METHOD AND APPARATUS FOR FORMING NANOPARTICLES

(71) Applicants: John Robertson, Cambridge (GB); C. Santiago Esconjauregui, Cambridge (GB)

(72) Inventors: John Robertson, Cambridge (GB); C. Santiago Esconjauregui, Cambridge (GB)

(73) Assignee: CAMBRIDGE ENTERPRISE LIMITED, Cambridge (GB)

(21) Appl. No.: 13/811,645

(22) PCT Filed: Jul. 19, 2011
(86) PCT No.: PCT/GB2011/001804

§ 371 Date: Jan. 22, 2013

(30) Foreign Application Priority Data
Jul. 19, 2010 (GB) 1012098.8

(51) Int. Cl. B01J 37/02; B01J 23/75; B01J 23/755; B01J 37/12; C01B 31/02; B01J 21/04; B01J 21/06; B01J 23/26; B01J 35/02; B01J 23/745; B01J 37/20

(52) U.S. Cl. CPC B01J 37/0221; B01J 23/745; B01J 23/75; B01J 23/755; B01J 37/12; B01J 37/20; B01J 21/04; B01J 21/063; B01J 23/26; B01J 21/066; B01J 35/02; C01B 31/0233
USPC 423/447.2; 502/100; 502/338; 502/325; 502/337; 502/5; 502/200; 502/216; 502/355; 502/350; 502/319; 502/349; 502/232; 502/240; 118/58; 118/620

(57) ABSTRACT

A first layer of a catalyst material is formed on a substrate and heat treated to form a first plurality of nanoparticles. A second layer of a catalyst material is then formed over the substrate and the first plurality of nanoparticles and heat treated to form a second plurality of nanoparticles. The first layer of nanoparticles is advantageously not affected by the deposition or heat treatment of the second layer of catalyst material, for example being pinned or immobilised, optionally by oxidation, before formation of the second layer.

### FIELD OF INVENTION

The invention provides a method and apparatus for forming nanoparticles, and in particular for forming catalytic nanoparticles over a substrate to serve as nuclei for carbon nanotube growth. The invention also provides a product comprising catalytic nanoparticles over a substrate.

### BACKGROUND

There has been a consistent drive over many years to reduce the size of electronic components in integrated circuits. Copper is currently the main material used to make the “interconnects” (i.e. the “flat” connectors in a circuit) and the “vias” (i.e. the “vertical” connectors between the different layers of an integrated circuit). In modern integrated circuit design, the desired sizes of interconnects and vias are now so small that current density is a limiting factor.

Carbon nanotubes (CNTs) can support very high current densities, and have therefore been proposed as a replacement for copper in the vias and interconnects of integrated circuits. However, to do this, the CNTs need to be grown in situ in high-density bundles, in order to produce CNT bundles having sufficiently low electrical resistivity/resistance. To achieve this they need to be grown directly by catalytic growth, and not put in place after growth. The conventional way to obtain high-density CNT growth is to deposit a thin film of a catalyst material (e.g. iron) onto a support (e.g. Al₂O₃), and then restructure the thin film by heat treatment so that it forms a series of nanoparticles. Each nanoparticle can then serve as a catalytic “seed” for the growth of a CNT (for example as described in U.S. Pat. No. 6,350,488 B1). However simple calculations show that the nanoparticle (and therefore CNT) densities using this method have an upper limit of about 10¹² cm⁻².

One reason for this is because the relationship between catalyst nanoparticle density N and the initial catalyst layer thickness h is found approximately to follow the relationship N˜1/(240 h²). The layer thickness h cannot easily be reduced below 0.3 nm, and care is required for thicknesses below 0.5 nm, or the film tends to disappear/diffuse into the support, or substrate, so this sets an upper limit of about 10¹² cm⁻² for the density of the nanoparticles produced.

Attempts have been made to maximise the nanoparticle density that can be formed in this way. It is found that if a thin layer of catalyst material is heat treated, then advantageously small nanoparticles can be formed, but only at an insufficient particle density. If a thicker layer of catalyst material is heat treated, disadvantageously larger nanoparticles are formed.

An alternative route, used by Fujitsu, is cluster beam deposition, in which a Co vapour beam is condensed into nanometre sized clusters, which are deposited on the substrate. But clustering requires an orifice, so the beam is disadvanthgeously narrow and needs to be scanned to cover a desired area of a substrate. In commercial production of integrated circuits, this may require scanning over the relatively very large area of a 12″ (30 cm) Si wafer, and so is expensive and impractical.

As well as using CNT bundles (also known as forests, arrays or mats) as conductors, similar CNT structures may be used as thermal interface materials. Here again, high CNT density is desirable in order to improve the performance of the structures.

The invention aims to solve these problems in the prior art and to enable the growth of CNTs at high density in a commercial and practical manner.

### SUMMARY OF INVENTION

The invention provides a method, a product and an apparatus as defined in the appended independent claims, to which reference should now be made. Preferred or advantageous features of the invention are set out in dependent subclaims.

In a first aspect, the invention may thus provide a method for fabricating catalyst nanoparticles to serve as growth nuclei for carbon nanotubes (CNTs), comprising steps (A) and (B) as follows. In step (A) a layer of a catalyst material is formed over a substrate, and is heat treated to form a plurality of catalyst nanoparticles over the substrate. In step (B) a further layer of a catalyst material is formed over both the substrate and the catalyst nanoparticles previously formed on the substrate, and is heat treated to form a further plurality of catalyst nanoparticles over the substrate.

It is surprising and counterintuitive that this process is effective because, prior to the present invention, the skilled person would have considered that the formation and heat treatment of the second layer of catalyst material in step (B) would disadvantageously change the structure of the nanoparticles previously formed on the substrate, and/or that the presence of the previously-formed nanoparticles would disadvantageously affect the formation of the further nanoparticles during the heat treatment in step (B). For example, it might be expected that during heat treatment of the layer of catalyst material in step (B), the previously-formed nanoparticles would act as nuclei for growth of larger catalyst particles, for example by sintering. Instead, the inventors have found, to their surprise, that the restructuring of the layer of catalyst material during heat treatment in step (B) may be largely independent of the existence of the previously-formed nanoparticles on the substrate surface, and that step (B) may simply form a further plurality of advantageously small catalyst nanoparticles over the substrate.

Thus, step (A) creates a first plurality of catalyst nanoparticles over the substrate at a particular density. Step (B) may then advantageously form a further plurality of catalyst nanoparticles, which cumulatively increases the density of nanoparticles over the substrate surface.

It is desirable to form small nanoparticles to serve as CNT growth nuclei, because the diameter of a CNT is related to the size of the nucleus from which it grows. Provision of a high density of small nanoparticles over a substrate may thus enable growth of a high density of small-diameter CNTs. As noted above, it is known from the prior art that in order to form advantageously small nanoparticles over a substrate by annealing a deposited layer, the layer should be as thin as possible. However, it is also known from the prior art that there is a limit to how thin a layer can be used, because the layer tends to be lost, or to diffuse into the substrate, during formation and heat treatment as described above. By forming and heat treating successive layers of catalyst material in steps (A) and (B), embodiments of the invention may instead allow the thickness of each deposited layer to be selected in order to produce nanoparticles of a desired size, while repetition of the steps of forming and heat treating the layers may allow the density of nanoparticles to be cumulatively increased and thus allow a desired density of nanoparticles to be built up.

Advantageously, in a preferred embodiment of the invention, step (B) may be repeated two or more times in order to form additional pluralities of nanoparticles over the substrate. Repeated formation and heat treatment of further layers of catalyst material over the substrate may thus advantageously form a cumulatively higher density of nanoparticles over the substrate. Since thin layers of catalyst material may be used in each repetition of step (B), the nanoparticles may be of advantageously small size.

Preferably, each layer of catalyst material in steps (A) and (B), and in any repetitions of step (B), may be of less than 1 nm average thickness or less than 0.75 nm or less than 0.5 nm or 0.3 nm average thickness. (The layers are not necessarily closed, and may be discontinuous or cracked, in which case the average layer thickness needs to be considered.)

Preferably, the nanoparticles formed by the method of the invention are of small size. Advantageously, they may be of less than 2 nm diameter. Advantageously, at least 90% of the nanoparticles formed over a substrate may be of less than 2 nm diameter.

The method of the invention may be implemented using any suitable catalyst material, including Fe and Co. Ni may also be used, as well as alloys containing Fe, Co or Ni. Other catalyst materials are also known for CNT nucleation, and may be used in embodiments of the invention, including Ru, Pd and Mo, and alloys containing these elements.

Successive layers of catalyst material, in steps (A) and (B), and/or in repetitions of step (B), may be of the same catalyst material or of different catalyst materials.

In a further embodiment of the invention, the nanoparticles formed over the substrate may be exposed to an oxidising or other atmosphere before the formation of a further layer of catalyst material over the substrate and the existing nanoparticles. For example, this may be done during heat treatment of the layer to form the nanoparticles.

This may advantageously form an oxide or other layer over the surface of the nanoparticles and/or the substrate, and may decrease any tendency for the formation and heat treatment of a further layer or layers of catalyst material to disadvantageously affect the nanoparticles already formed on the substrate.

When a further layer of catalyst material is formed over nanoparticles already formed on a substrate it is important to avoid significant sintering of the existing nanoparticles. If such sintering occurs, it may disadvantageously increase the size of the existing nanoparticles and consume catalyst material intended for the formation of new nanoparticles. It is envisaged that sintering may be prevented by various mechanisms, in which the existing nanoparticles have reduced mobility, or are converted into an immobile form, compared with the catalyst material in the further layer(s) deposited over them, or in which interaction with the material in the further layer(s) is prevented or reduced.

As mentioned above, one way to achieve this may be to oxidise the nanoparticles, for example to form an oxide layer over the surface of the nanoparticles during or after the formation of the nanoparticles, by exposure to an oxidising atmosphere. Only a thin oxide layer may be needed. An atomic monolayer of oxide may be sufficient.

The nature of the oxidising atmosphere required may depend on factors such as the material from which the nanoparticles are formed, the activity of oxygen required to form an oxide layer on the material, and the temperature at which the nanoparticles are exposed to the oxidising atmosphere. For example, if the nanoparticles contain Fe (which is relatively easily oxidised), only a low partial pressure of oxygen in the atmosphere in the heat treatment chamber during nanoparticle formation (which may be at elevated temperature) may be sufficient. There may even be a sufficient partial pressure of oxygen in a conventional inert atmosphere used during such a heat treatment, which will typically contain a small amount of O₂ and/or H₂O.

Nanoparticles comprising other materials, such as Co or Ni, may require higher partial pressures of oxygen in order to form surface oxide layers.

By way of example, an atmosphere containing a partial pressure of oxygen of between about 10⁻¹ Torr and about 10⁻⁶ Torr, or between 10⁻⁴ Torr and 10⁻⁶ Torr, or a partial pressure of H₂O between about 10⁻¹ Torr and 10⁻⁵ or 10⁻⁶ Torr, may be sufficient. If the atmosphere can be controlled to lower partial pressures, partial pressures down to 10⁻⁷ Torr may even be sufficient, at least for some catalyst materials. Different catalyst materials may require exposure to different partial pressures of H₂O or O₂. For example Fe may only require exposure to a partial pressure at the lower end of the ranges given above, whereas Co or Ni may require exposure to a partial pressure at the higher end of those ranges.

Other oxidising atmospheres may be used, such as atmospheres containing N₂O, or oxidising plasmas. Plasmas may preferably be used at pressures between 10⁻¹ and 10⁻³ Torr. Reducing atmospheres may be disadvantageous.

Surface layers of materials other than oxides may be formed on the nanoparticles, such as sulphide layers, by using atmospheres containing sulphur or sulphides. N₂ plasmas may also be used to form nitrides rather than oxides (see Example 4 below).

Exposure to oxidising or other atmospheres may also modify the bonding between nanoparticles and the substrate, effectively pinning the nanoparticles to the substrate and reducing their tendency to sinter.

Exposure to oxidising or other atmospheres may typically be within the temperature range 300-750° C. Exposure to plasmas may be within this temperature range, but depending on the ease of oxidation of the catalyst material, may not require an elevated temperature. Processing temperatures may need to be selected in view of factors such as the temperature sensitivity of the substrate, or of any other devices or structures attached to or forming part of the substrate. For example if the substrate is part of an electronic device during fabrication, other portions of the device may not be able to tolerate elevated temperatures. In such cases temperatures of less than 400° C. are typically desirable and so annealing to form nanoparticles may be carried out in the temperature range 300-400° C. or even 250-400° C. Plasma processing may advantageously allow lower temperatures to be used such as in the range 200-250° C. It may be advantageous to use inductively-coupled plasmas to avoid ion bombardment of sensitive structures on the substrate, if required.

The inventors have found that the formation of oxides or alternative approaches to reducing the mobility of the nanoparticles, or immobilising the nanoparticles, may not detrimentally affect the ability of the nanoparticles subsequently to nucleate the growth of CNTs, or the electrical conductivity of the CNTs. This may depend on the materials involved and/or the thickness of any oxide, oxide layer or other material involved in immobilising the nanoparticles. If, however, the formation of oxide or other approach to reducing the mobility of the nanoparticles does adversely affect CNT growth or conductivity, then the nanoparticles may be converted back to their metallic state, or to a state suitable for CNT growth, before growth of the CNTs. For example, if nanoparticles have been oxidised, they may be reduced, for example by exposure to a suitable reducing agent such as a reducing atmosphere or plasma, before CNT growth. Alternatively, the CNT growth may be carried out in an atmosphere which is sufficiently reducing to reduce the oxide.

A further embodiment of the invention may include the step of depositing a thin layer of Al over the substrate and over any nanoparticles formed on the substrate, for example by sputtering, before the step of exposure to the oxidising atmosphere. This may advantageously enable formation of a thin layer of Al₂O₃ during exposure to the oxidising atmosphere, to enhance isolation between the existing nanoparticles and the subsequently-formed layer of catalyst material. Surprisingly, the inventors have found that the presence of such a layer of Al₂O₃ does not affect the ability of a nanoparticle subsequently to nucleate the growth of a CNT, and the layer is sufficiently thin that it does not affect the electrical conductivity of the CNT. It may be advantageous to deposit the Al layer as a layer sufficiently thin that the resulting Al₂O₃ layer is discontinuous, to minimise any impact of the layer on the catalytic effect of the nanoparticles on subsequent CNT nucleation, and the electrical resistance of the layer.

Materials other than Al may be used in a similar way, such as Cr, Ti, Zr or Hf.

If a thicker layer of Al₂O₃ or other material is formed which may detrimentally affect the ability of a nanoparticle subsequently to nucleate the growth of a CNT, or which may affect the electrical conductivity of the CNT, then the oxide may be converted back to the metallic state before growth of the CNT by exposure to a suitable reducing agent, such as a suitable reducing atmosphere or plasma. Alternatively, the CNT growth may be carried out in an atmosphere which is sufficiently reducing to reduce the oxide.

The substrate may be formed from any suitable material. Examples include alumina, silica, silica following an oxidising pre-treatment, silicides or nitrides. Advantageously, if CNTs are to be grown for electrical conduction, the substrate may be a conductor such as a conductive metal silicide or metal nitride.

The substrate over which the nanoparticles are formed may comprise a coating or layer of a suitable substrate material which has been formed or deposited over a different underlying material. If Al₂O₃ or other electrical insulators are used, they should generally be in the form of a very thin layer in order to minimise the electrical or thermal resistance of the substrate. For example, in the prior art an Al 99.5 wt %/Cu 0.5 wt % alloy has been used, which forms only a very thin Al₂O₃ surface layer.

The process of heat treating a layer of catalyst material may involve annealing the layer to form drops, or droplets, in the form of nanoparticles. A typical heat treatment includes a step of increasing the temperature of the layer of catalyst material and the substrate to a predetermined annealing temperature, and holding the temperature at the predetermined annealing temperature for a predetermined length of time. The inventors have found that it may be advantageous to raise the temperature to the predetermined annealing temperature at different rates in steps (A) and (B). Preferably, the rate of temperature increase may be higher in step (A) than in step (B) and/or in any repetitions of step (B).

Advantageously, the method of the first aspect of the invention may achieve the formation of nanoparticles at a density over the substrate equal to or greater than 5×10¹² cm⁻², or 10¹³ cm⁻², or preferably 5×10¹³ cm⁻², or particularly preferably 10¹⁴ cm⁻².

These nanoparticle densities may be used to grow CNTs at comparable densities, which may advantageously be high enough to provide electrical interconnects of very low resistivity, able to carry very high current densities.

In a second aspect, the invention may advantageously provide a substrate provided with catalyst nanoparticles to serve as growth nuclei for CNTs. This may be fabricated as described above.

Advantageously, the distribution of nanoparticles on the substrate may be a distribution which could not have been formed by the heat treatment of a single layer of catalyst material, as in the prior art. Thus, as described above, the prior-art method of heat treating a single layer of catalyst material may not be able to produce nanoparticle densities above about 10¹² cm⁻². By contrast, embodiments of the invention may provide a substrate carrying catalyst nanoparticles at a density greater than 5×10¹² cm⁻², 10¹³ cm⁻², preferably 5×10¹³ cm⁻², or particularly preferably 10¹⁴ cm⁻². Preferably, the nanoparticles may be of advantageously small size, for example at least 90% of the nanoparticles may be of less than 2 nm diameter.

Fabricating a product, in the form of a substrate provided with catalyst nanoparticles embodying the invention, involves the successive formation and heat treatment of two of more layers or films of catalyst material. Consequently, the product may comprise a number of separately-identifiable pluralities of nanoparticles. For example, the plurality of nanoparticles formed in step (A) may be identifiable and distinguishable from the nanoparticles formed in step (B) due to the fact that the nanoparticles formed in step (A) have additionally been subjected to the heat treatment in step (B), or may have been formed using a different heat treatment if different heat treatments were used in steps (A) and (B). For example, different heat treatments of layers of catalyst material may produce nanoparticles of different sizes or different spatial distributions on the substrate. Similarly, if step (B) was repeated, then three or more separately-identifiable pluralities of nanoparticles may have been formed on the substrate.

It is known that the heat treatment of layers of catalyst material of different thicknesses may produce nanoparticles of different sizes and/or spatial distributions. Consequently, if layers of catalyst material of different thicknesses were used in steps (A) and (B) (and any further iterations of step (B)), then the product may comprise two or more separately identifiable pluralities of nanoparticles of different sizes and/or spatial distributions.

If during fabrication of a product the substrate and a first or subsequent plurality of nanoparticles was exposed to an oxidising atmosphere before formation of a further layer of catalyst material, or if a layer of Al or other material was deposited before the formation of a further layer of catalyst material, then different pluralities of nanoparticles formed in different steps may comprise different materials or may have different surface layers. For example, if a layer of aluminium were deposited before the formation of each layer of catalyst material (other than the first layer of catalyst material), then all of the nanoparticles may comprise a surface layer of Al₂O₃ except for the plurality of nanoparticles formed in the last iteration of step (B). In a particular embodiment, if three pluralities of nanoparticles have been formed, by performing step (A), step (B) and repeating step (B), and a layer of Al was deposited before each iteration of step (B), the nanoparticles formed in step (A) would have been subjected to two depositions of Al layers. Inspecting the end product may then reveal a first plurality of nanoparticles formed in step (A), covered by a double thickness of Al₂O₃, a second plurality of nanoparticles formed in the first iteration of step (B), covered with a single layer of Al₂O₃, and a third plurality of nanoparticles formed in the second iteration of step (B) covered with no layer of Al₂O₃.

A similar pattern may be observed in a substrate provided with nanoparticles in which each plurality of nanoparticles was exposed to an oxidising atmosphere before the formation of the subsequent layer of catalyst material, because different pluralities of nanoparticles will have been exposed to the oxidising atmosphere more or less often than other pluralities of nanoparticles.

Further, if different materials were used for successive layers of catalyst material during fabrication of the substrate provided with the catalyst nanoparticles, then the product would comprise separate pluralities of nanoparticles formed with the different catalyst materials.

A further aspect of the invention provides a conducting element formed from carbon nanotubes grown on a substrate provided with catalyst nanoparticles as described above.

In a further aspect, the invention also provides an electronic device comprising a conducting element formed from carbon nanotubes as described above.

In a still further aspect, the invention may advantageously provide an apparatus for fabricating catalyst nanoparticles over a substrate, to serve as growth nuclei for CNTs. The apparatus may advantageously comprise a reactor for forming a layer of a catalyst material over a substrate, a heater for heat treating the layer of catalyst material to form a plurality of catalyst nanoparticles, and a controller for controlling the apparatus. The controller advantageously controls the apparatus to repeat the formation of layers of catalyst material and the heat treatment to form one or more further pluralities of catalyst nanoparticles.

The apparatus may advantageously comprise a nanoparticle-pinning or nanoparticle-immobilising reactor, for example in the form of an apparatus such as an oxidation apparatus for exposing the substrate and any nanoparticles formed thereon to an oxidising atmosphere or other atmosphere or plasma as described herein, and/or in the form of an intermediate reactor for depositing and/or oxidising a layer of Al (or Cr, Ti, Zr of Hf or other suitable material), to reduce the mobility of, or immobilise, the nanoparticles before the formation of a further layer of catalyst material. The nanoparticle-pinning reactor (or oxidation apparatus and/or intermediate reactor) may be the same as the reactor for forming and heat treating each layer of catalyst material, suitably controlled by the controller. The reactor, or oxidation apparatus, may optionally provide exposure to an oxidising atmosphere during the heat treatment to form the nanoparticles.

In the various aspects of the invention described above, reference has been made to heat treating each layer of catalyst material, for example to anneal the layer and form drops, droplets, or nanoparticles. The heat treatment may be applied in any suitable way. For example, the substrate and the layer of catalyst material may be heated in a furnace or other reactor, but other methods may be used such as scanning with an energy beam, such as laser heating, for example by scanning a laser across a surface of the layer of catalyst material.

### DESCRIPTION OF SPECIFIC EMBODIMENTS AND BEST MODE OF THE INVENTION

Specific embodiments of the invention will now be described by way of example with reference to the drawings, in which:

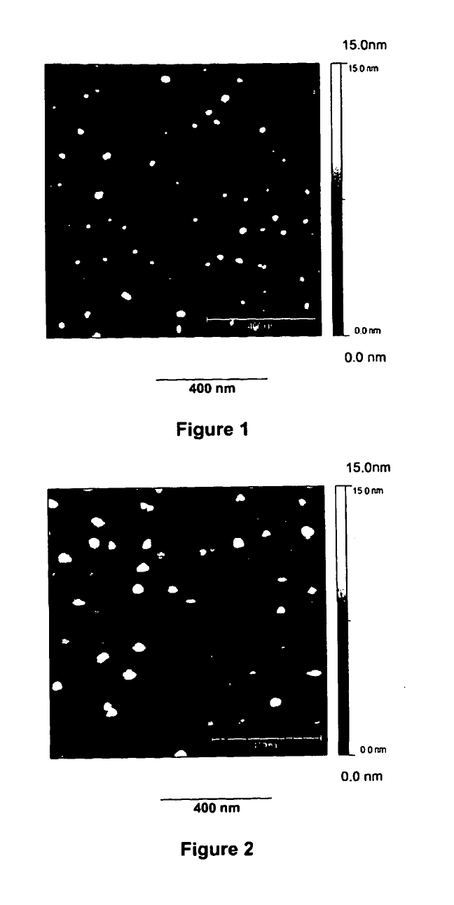

FIG. 1 is an AFM (atomic force micrography) image of a substrate after formation of a first plurality of nanoparticles;

FIG. 2 is an AFM image of the surface of the substrate of FIG. 1 after formation of a second plurality of nanoparticles;

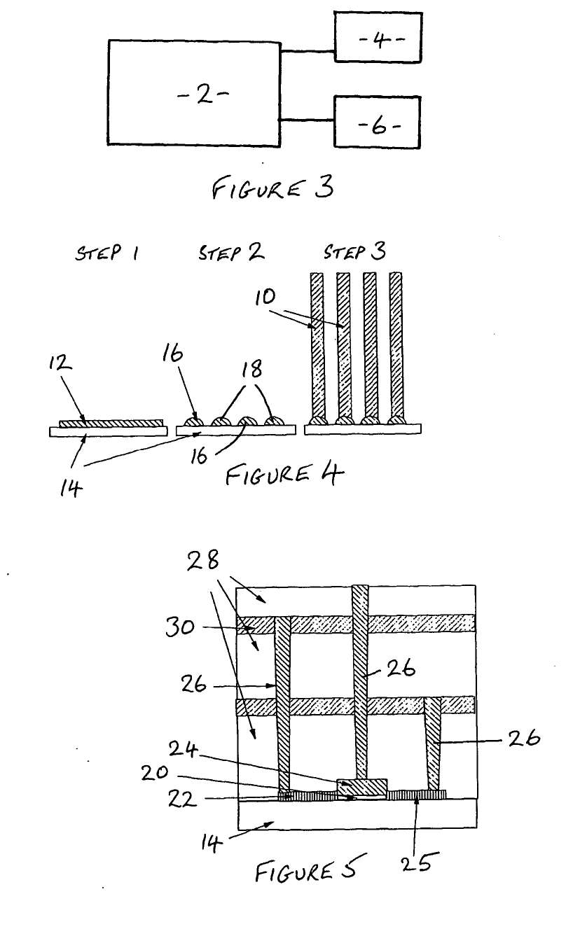

FIG. 3 illustrates an apparatus for fabricating nanoparticles according to an embodiment of the invention;

FIG. 4 is a schematic diagram of three steps in the formation of a bundle of carbon nanotubes, embodying the invention; and

FIG. 5 is a schematic diagram of an electronic structure comprising vertical interconnects in the form of bundles of CNTs, fabricated according to an embodiment of the invention.

### Example 1

In a first example of the invention, first and second pluralities of Fe nanoparticles were formed on an Al₂O₃ substrate. The procedure for formation of the first plurality of nanoparticles (step (A)) was as follows.

A layer of Fe of 0.3 nm average thickness was deposited by evaporation onto the substrate. The substrate, with the Fe layer, was transferred to an annealing chamber, in which the substrate and the Fe layer were heated from room temperature up to 700° C. at 75° C. min⁻¹, and held at 700° C. for several minutes. The annealing process was carried out in an atmosphere of Ar:H₂ flowing through the annealing chamber at 0.5 l.min⁻¹(Ar) and 0.2 l.min⁻¹(H₂) at 1 bar. The annealing chamber was in the form of a furnace tube.

FIG. 1 shows the distribution of catalyst nanoparticles on the substrate after this first step (A). (Note that in the AFM image the sizes of the images of the nanoparticles may be larger than the sizes of the nanoparticles themselves.) The second plurality of nanoparticles (step (B)) was then formed as follows.

The substrate carrying the first plurality of nanoparticles was transferred in air to a reactor in which a further layer of Fe of 0.3 nm average thickness was deposited by evaporation over both the substrate and the first plurality of Fe nanoparticles. The substrate carrying this second layer of Fe was then transferred to the annealing chamber and heat treated in the same way as the first layer described above, except that the substrate and the Fe layer were heated from room temperature up to 700° C. at a lower rate of 25° C. min⁻¹.

In this second step (step (B)), a second plurality of Fe nanoparticles was formed, as shown in FIG. 2. FIG. 2 clearly shows the two separate pluralities of nanoparticles formed in steps (A) and (B). The nanoparticles formed in step (A) are larger in diameter than those formed in step (B), and have not been significantly affected by the deposition and heat treatment of the subsequent Fe layer. FIG. 2 clearly shows the first plurality of larger, more widely spaced nanoparticles and the second plurality of smaller, more closely spaced nanoparticles.

### Example 2

In a second example, an Al₂O₃ substrate was used as in Example 1. A layer of Fe of 0.3 nm average thickness was first deposited by evaporation onto the substrate, followed by a layer of Al of 0.3 nm average thickness, again deposited by evaporation. The substrate, with the deposited layer (comprising the Fe and Al sub-layers), was then transferred to an annealing chamber and heat treated in the same way as in step (A) of Example 1.

This produced a first plurality of Fe/AI nanoparticles over the substrate. A further layer of Fe of 0.3 nm was then deposited by evaporation over the substrate and over the plurality of Fe/Al nanoparticles, and transferred to the annealing chamber for heat treatment under the same conditions as in step (B) of Example 1.

This produced a second plurality of nanoparticles, distributed amongst the first plurality of nanoparticles formed in step (A) above. In this case, it should be noted that the two pluralities of nanoparticles are of different composition from each other, the first being formed from Fe/Al and the second from Fe.

### Example 3

In a third example of the invention, first and second pluralities of Fe nanoparticles were formed on an Al₂O₃ substrate. The procedure for formation of the first plurality of nanoparticles (step (A)) was as follows.

A layer of Fe of 0.3 nm average thickness was deposited by evaporation onto the substrate. The substrate, with the Fe layer, was then annealed at a temperature of 700° C. for several minutes in an atmosphere of Ar:H₂ flowing through the annealing chamber at 0.5 l.min⁻¹(Ar) and 0.2 l.min⁻¹(H₂) at 1 bar. The atmosphere contained H₂O at a partial pressure of about 10⁻⁶ Torr.

A further layer of Fe of 0.3 nm average thickness was then deposited by evaporation over both the substrate and the first plurality of Fe nanoparticles. The substrate carrying this second layer of Fe was then heat treated in the same way as the first layer described above.

In this second step (step (B)), a second plurality of Fe nanoparticles was formed.

FIG. 3 illustrates an apparatus suitable for implementing this method, comprising a reactor 2, a programmable controller 4 for controlling the reactor temperature, and a gas control unit 6 for controlling the composition and pressure of the atmosphere in the reactor. The reactor comprises a deposition means for forming each layer on the substrate prior to annealing. A similar apparatus may be used for Example 4 below.

### Example 4

In a fourth example of the invention, first and second pluralities of Fe nanoparticles were formed on an Al₂O₃ substrate. The procedure for formation of the first plurality of nanoparticles (step (A)) was as follows.

A layer of Fe of 0.3 nm average thickness was deposited by evaporation onto the substrate. The substrate, with the Fe layer, was then given an oxidative treatment in an O₂ plasma at 230° C. for several minutes, both to form the Fe layer into nanoparticles and to convert the nanoparticles into an immobile form. A N₂ plasma treatment may also be effective for this.

A further layer of Fe of 0.3 nm average thickness was then deposited by evaporation over both the substrate and the first plurality of nanoparticles. The substrate carrying this second layer of Fe was then plasma processed in the same way as the first layer described above, to form a second plurality of Fe nanoparticles.

### Example 5

In a fifth example, first and second pluralities of Fe nanoparticles were formed on an Al₂O₃ substrate using the same processing parameters as in Example 1, except that after deposition and annealing of the first Fe layer to form the first plurality of nanoparticles (step (A)), a layer of Al of average thickness 0.2 nm was deposited by evaporation over the first plurality of nanoparticles and the substrate. When the substrate carrying the first plurality of nanoparticles and the Al layer was transferred in air from the annealing chamber to the reactor for further Fe deposition, the layer of Al oxidised to form a surface layer of Al₂O₃. This immobilised the first plurality of nanoparticles during the deposition and annealing of the further Fe layer to form the second plurality of nanoparticles, and prevented further sintering of the first plurality of nanoparticles.

In each of the Examples above, at least some of the nanoparticles in the final product are in the form of oxides, or comprise surface oxide layers, or have otherwise been pinned or immobilised prior to formation of further nanoparticles. If required, the nanoparticles can be exposed to a reducing agent, such as a reducing atmosphere of H₂ or NH₃, for a predetermined time and at a predetermined gas or plasma concentration and temperature, to reduce the oxide before CNT growth.

FIG. 4 illustrates the fabrication of a bundle of carbon nanotubes. In a first step, shown at the left hand side of FIG. 4, a layer of catalyst material 12 is deposited on a substrate 14. The substrate and the layer of catalyst material are annealed, as described above, to form a plurality of nanoparticles 16 on the substrate. Steps one and two are then repeated, as described above, in order to form further nanoparticles 18. Finally, a carbon nanotube 10 is grown on each catalytic nanoparticle to form the bundle of nanotubes, as shown in step 3 in FIG. 4.

FIG. 5 is a schematic illustration of an electronic device comprising vertical interconnects formed from bundles of CNTs. A FET (field-effect transistor) 20, comprising a source contact 22, a gate electrode 24 and a drain electrode 25 is formed on a substrate 14. After suitable masking, catalytic nanoparticles were formed on the source, gate and drain, using an embodiment of the invention, to provide nuclei for the growth of vertical interconnects 26 in the form of bundles of CNTs. These vertical interconnects pass through layers of inter-metal dielectric 28 to make contact with horizontal interconnects 30, in known manner.

1. A method for fabricating catalyst nanoparticles to serve as growth nuclei for carbon nanotubes (CNTs), comprising the steps of:
(A) forming a layer of a catalyst material over a substrate, and heat treating the layer to form a plurality of catalyst nanoparticles; and
(B) forming a further layer of catalyst material over the substrate and the catalyst nanoparticles, and heat treating the further layer to form a further plurality of catalyst nanoparticles.

2. A method according to claim 1, in which step (B) is repeated to form one or more additional further pluralities of nanoparticles.

3. A method according to claim 1, in which each layer of catalyst material is of less than 1 nm average thickness.

4. A method according to any preceding claim 1, in which at least one or more of the layer and the further layers are is not closed.

5. A method according to any preceding claim 1, in which the layer and the further layer(s) are of the same material.

6. A method according to any of claims 1 to 4, in which the layer and the further layer(s) are not of the same material.

7. A method according to any preceding claim 1, in which at least one of the layer and the further layer(s) is a composite layer comprising more than one sub-layer.

8. A method according to any preceding claim 1, in which at least 90% of the nanoparticles are of less than 2 nm diameter.

9. A method according to any preceding claim 1, in which the catalyst material comprises Fe, Co or Ni.

10. A method according to any preceding claim 1, in which the substrate comprises a material selected from the group consisting of alumina, silica, silica following an oxidising pre-treatment, metal silicides and metal nitrides.

11. A method according to any preceding claim 1 for forming nanoparticles over the substrate at a density equal to or greater than 5×10¹² cm² or 10¹³ cm², or preferably 5×¹³ cm², or particularly preferably 10¹⁴ cm².

12. A method according to any preceding claim 1, in which each heat treatment heat treating includes a step of increasing temperature to a predetermined annealing temperature, and in which the rate of the temperature increase is higher in step (A) than in step (B).

13. A method according to any preceding claim 1, including the step of exposing the substrate and the nanoparticles formed over the substrate to an oxidizing or nitriding atmosphere, such as a plasma, or an atmosphere containing surphur or sulphides, before the formation of the further layer of catalyst material.

14. A method according to claim 13, in which the exposure to the oxidizing or other atmosphere nitriding occurs during the heat treatment to form the nanoparticles.

15. A method according to claim 13 or 14, including the step of depositing a layer comprising a material selected from the group comprising Al, Ti, Cr, Zr and Hf over the substrate and the nanoparticles formed over the substrate, and then exposing the deposited layer to an oxidising atmosphere.

16. A substrate provided with catalyst nanoparticles to serve as growth nuclei for carbon nanotubes, fabricated using a method as defined in any of claims 1 to 15.

17. An electronic device comprising a conducting element formed from carbon nanotubes grown on a substrate provided with catalyst nanoparticles, in which the nanoparticles are fabricated as defined in any of claim(s) 1 to 15.

18. A substrate provided with catalyst nanoparticles to serve as growth nuclei for carbon nanotubes, in which the nanoparticles comprise first and second pluralities of nanoparticles formed over the same substrate.

19. An electronic device comprising a conducting element formed from carbon nanotubes grown on a substrate provided with catalyst nanoparticles, in which the nanoparticles comprise first and second pluralities of nanoparticles formed over the same substrate.

20. An apparatus for fabricating catalyst nanoparticles to serve as growth nuclei for carbon nanotubes, comprising:
a reactor for forming a layer of a catalyst material over a substrate;
a heater for heat treating the layer of catalyst material to form a plurality of catalyst nanoparticles; and
a controller for controlling the apparatus to repeat the formation of layers of catalyst material and the heat treatment to form one or more further pluralities of catalyst nanoparticles.

21. An apparatus according to claim 20, further comprising:
an oxidation apparatus for exposing the substrate and any nanoparticles already formed over the substrate to an oxidizing or nitriding atmosphere, such as a plasma, or an atmosphere containing sulphur or sulphides, before the formation of the second and any subsequent layers of catalyst material.

22. An apparatus according to claim 21, further comprising:
an intermediate reactor for depositing a layer of a material selected from the group comprising Al, Ti, Cr, Zr and Hf over the substrate and any nanoparticles already formed over the substrate before each exposure to the oxidising atmosphere.

23. (canceled)

24. (canceled)

25. (canceled)

26. A method according to claim 2, in which each layer of catalyst material is of less than 1 nm average thickness.

27. A method according to claim 2, in which at least one layer is not closed.

28. A method according to claim 2, in which the layer and the further layer are of the same material.

29. A method according to claim 2, in which the layer and the further layer are not of the same material.

30. A method according to claim 2, in which at least one of the layer and the further layer is a composite layer comprising more than one sub-layer.

31. A method according to claim 2, in which at least 90% of the nanoparticles are of less than 2 nm diameter.
